(19) United States
(12) Patent Application Publication
(10) Pub. No.: US 2008/0180374 A1
(43) Pub. Date: Jul. 31, 2008

(54) ELECTRO-OPTICAL DEVICE, PROCESSING CIRCUIT, PROCESSING METHOD, AND PROJECTOR

(75) Inventor: Hiroshi YOSHIMOTO, Suwa-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/948,452

(22) Filed: Nov. 30, 2007

(30) Foreign Application Priority Data
Jan. 31, 2007 (JP) 2007-021970

(51) Int. Cl. G09G 3/36

(52) U.S. Cl. 345/89

(57) ABSTRACT

A processing circuit includes an adder circuit that adds, when converting image data into one of a positive and negative data signals, a correction value stored in a storage unit to the image data, and, when converting the image data into the other of the positive and negative data signal, adds a sign-inverted value of the correction value stored in the storage unit to the image data.

### BACKGROUND

1. Technical Field

The present invention relates to the technique of avoiding application of a direct-current (DC) component to an electro-optical material, such as liquid crystal.

2. Related Art

Liquid crystal displays (LCDs) are generally driven on the basis of an alternating-current (AC) driving method in which high-level (positive) and low-level (negative) voltages are alternately applied to a counter electrode in order to prevent degradation of liquid crystal caused by applying a DC component to liquid crystal capacitors (pixels) formed by sandwiching liquid crystal between pixel electrodes and the counter electrode.

For an active matrix type in which the pixel electrodes are driven by thin film transistors (hereinafter abbreviated as “TFTs”), because push-down or the like occurs, the technique of shifting voltage applied to the counter electrode with respect to a reference of the polarity, and correcting only one of positive voltage and negative voltage applied to the pixel electrodes but not correcting the other voltage applied to the pixel electrodes is proposed (e.g., see JP-A-2002-112623).

A weak point has been noted regarding this technique of correcting one of positive and negative voltages. That is, the gray levels (brightness) of pixels are likely to change, as compared with the case in which no correction is performed at all.

An advantage of some aspects of the invention is that the invention provides a processing circuit, a processing method, an electro-optical device, and a projector for suppressing changes in gray levels, as compared with the case in which no correction is performed at all, while avoiding application of a DC component to liquid crystal capacitors.

According to an aspect of the invention, there is provided a processing circuit for correcting image data specifying a gray level of a pixel and for converting the image data alternately into a data signal having a positive voltage and a data signal having a negative voltage with reference to a predetermined potential on the basis of the corrected image data. The processing circuit includes the following elements: a storage unit that stores a correction value for correcting the image data in association with the gray level specified by the image data in the case where the image data is to be converted into the data signal with one of the positive voltage and the negative voltage; and an adder circuit that adds, when converting the image data into the data signal with one of the positive voltage and the negative voltage, the correction value stored in the storage unit to the image data, and, when converting the image data into the data signal with the other one of the positive voltage and the negative voltage, adds a sign-inverted value of the correction value stored in the storage unit to the image data, and outputs the sum as the corrected image data. According to the aspect of the invention, application of a DC component to liquid crystal. capacitors constituting pixels can be avoided, and changes in gray levels can be suppressed.

It is preferable that the storage unit store correction values corresponding to some of gray levels specifiable by pieces of image data, and the processing circuit further include an interpolation circuit that computes a correction value corresponding to, among the gray levels specifiable by the pieces of image data, a gray level other than the gray levels corresponding to the stored correction values by interpolating the stored correction values. Accordingly, only a small storage capacity is needed for the storage unit.

It is preferable that the processing circuit further include a timing adjusting circuit that delays supply of the image data to the adder circuit by a time required for computing the correction value corresponding to the image data or the sign-inverted value of the correction data and to supply the delayed image data to the adder circuit.

The aspect of the invention can be conceived not only as the processing circuit but also as a processing method.

According to another aspect of the invention, there is provided an electro-optical device including the following elements: a processing circuit that corrects image data specifying a gray level of a pixel and converts the image data alternately into a data signal having a positive voltage and a data signal having a negative voltage with reference to a predetermined potential on the basis of the corrected image data; a plurality of pixels provided at intersections between a plurality of scanning lines in rows and a plurality of data lines in columns, wherein each of the pixels is displayed with a gray level in accordance with a voltage of a data signal supplied to a corresponding one of the data lines in the case where a corresponding one of the scanning lines is selected; a scanning-line drive circuit that selects the plurality of scanning lines in rows one at a time in a predetermined sequence; and a data-line drive circuit that supplies data signals processed by the processing circuit to pixels positioned along a selected scanning line via the corresponding data lines. The processing circuit includes the following elements: a storage unit that stores a correction value for correcting the image data in association with the gray level specified by the image data in the case where the image data is to be converted into the data signal with one of the positive voltage and the negative voltage; and an adder circuit that adds, when converting the image data into the data signal with one of the positive voltage and the negative voltage, the correction value stored in the storage unit to the image data, and, when converting the image data into the data signal with the other one of the positive voltage and the negative voltage, adds a sign-inverted value of the correction value stored in the storage unit to the image data, and outputs the sum as the corrected image data. According to the aspect of the invention, application of a DC component to liquid crystal capacitors constituting pixels can be avoided, and changes in gray levels can be suppressed.

According to another aspect of the invention, there is provided a projector including at least three electro-optical devices as described above, which correspond to primary colors. Images generated by these at least three electro-optical devices are combined. At least three storage units included in these at least three electro-optical devices store the same correction values.

### BRIEF DESCRIPTION OF THE DRAWINGS

The invention will be described with reference to the accompanying drawings, wherein like numbers reference like elements.

FIG. 1 is a block diagram of the structure of an electro-optical device according to an embodiment of the invention.

FIG. 2 is a diagram of the structure of pixels included in the electro-optical device.

FIG. 3 is a block diagram of the structure of an image-data processing circuit included in the electro-optical device.

FIG. 4 is a graph showing correction values stored in a look-up table (LUT) in the image-data processing circuit.

FIGS. 5A and 5B are graphs showing correction values and sign-inverted values in the image-data processing circuit.

FIGS. 6A to 6C are charts showing settings of correction values stored in the LUT.

FIG. 7 is a chart showing an operation of writing data signals in the electro-optical device.

FIG. 8 is a chart showing an operation of writing data signals in the electro-optical device.

FIG. 9 is a plan view of the structure of a projector to which the electro-optical device according to the embodiment is applied.

FIG. 10 is a block diagram of the structure of correction circuits included in the projector.

### DESCRIPTION OF EXEMPLARY EMBODIMENTS

An embodiment of the invention will now herein be described with reference to the drawings.

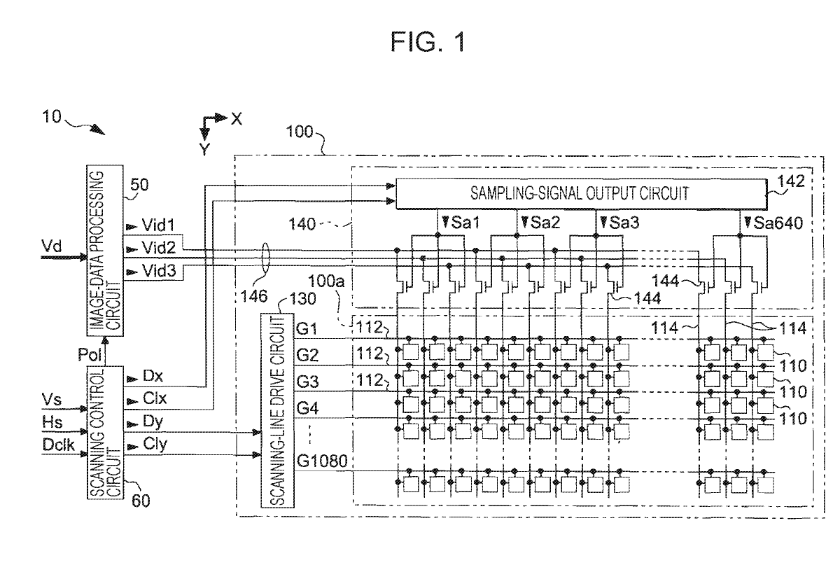

FIG. 1 is a block diagram of the overall structure of an electro-optical device according to an embodiment of the invention. As shown in FIG. 1, an electro-optical device 10 according to the embodiment includes an image-data processing circuit 50, a scanning control circuit 60, and a display panel 100. Of these components, the scanning control circuit 60 controls the image-data processing circuit 50 and components of the display panel 100 in accordance with a vertical synchronization signal Vs, a horizontal synchronization signal Hs, and a dot clock signal Dclk, which are supplied from an upper-level unit (not shown).

Under control of the scanning control circuit 60, the image-data processing circuit 50 corrects digital image data Vd, converts the corrected digital image data Vd into three channels of data signals (image signals) Vid1, Vid2, and Vid3, and outputs the data signals (image signals) Vid1, Vid2, and Vid3 to three image signal lines 146, respectively. This operation will be described in detail later.

The image data Vd specifies the gray level (luminance) of a pixel using 256 levels from the darkest black “0” to the brightest white “255”. Data for each of pixels of the display panel 100 is supplied in synchronization with the vertical synchronization signal Vs, the horizontal synchronization signal Hs, and the dot clock signal Dclk (that is, in accordance with vertical scanning and horizontal scanning). According to the embodiment, the image data Vd is expanded to three channels because, according to the embodiment, the period in which one pixel portion of the image data Vd is supplied is expanded three times along the time axis (which is also referred to as phase expansion or serial-to-parallel conversion) in order to ensure a sufficient sampling time of data signals using TFTs 144, which will be described later.

When converting image data Vd for a certain pixel into a data signal having a voltage in accordance with the gray level of that pixel, the image-data processing circuit 50 alternately generates a data signal with a high-level (positive) voltage and a data signal with a low-level (negative) voltage with reference to a voltage Vc, which will be described later. The polarity is inverted in order to prevent degradation of liquid crystal due to application of a DC component. Whether to write a signal with a positive or negative voltage to each pixel can be changed on a scanning-line-by-scanning-line basis, a data-line-by-data-line basis, a pixel-by-pixel basis, a frame-by-frame basis, or the like. According to the embodiment, in order to simplify the description, the polarity is inverted on a scanning-line-by-scanning-line basis. However, the invention is not limited to the embodiment.

According to the embodiment, the polarity of a data signal is determined with reference to the voltage Vc. Regarding voltages, if not stated otherwise, a ground potential Gnd corresponding to L level which is a logical level described later serves as a zero-volt reference.

The display panel 100 performs a predetermined display operation using liquid crystal. The display panel 100 contains built-in peripheral circuits including a scanning-line drive circuit 130 and a data-line drive circuit 140 provided around a display area 100a.

The display area 100a is an area where pixels 110 are arranged. According to the embodiment, 1080 rows of scanning lines 112 are provided in a horizontal direction (X direction). At the same time, 1920 (=640×3) columns of data lines 114 are provided in a vertical direction (Y direction). The pixels 110 are provided at corresponding intersections between the scanning lines 112 and the data lines 114. Therefore, according to the embodiment, the pixels 110 are arranged in a matrix of 1080 rows by 1920 columns in the display area 100a.

Under control of the scanning control circuit 60, the scanning-line drive circuit 130 supplies scanning signals G1, G2, G3, . . . , and G1080 to the scanning lines 112 in the first, second, third, . . . and 1080-th rows over a vertical scanning period (frame). More specifically, the scanning-line drive circuit 130 selects the scanning lines 112 one at a time in order from the top of FIG. 1, that is, the first, second, third, . . . , and 1080-th rows. A scanning signal supplied to the selected scanning line is at H level corresponding to a voltage Vdd, and scanning signals supplied to the other scanning lines are at L level corresponding to a non-selection voltage (ground potential Gnd).

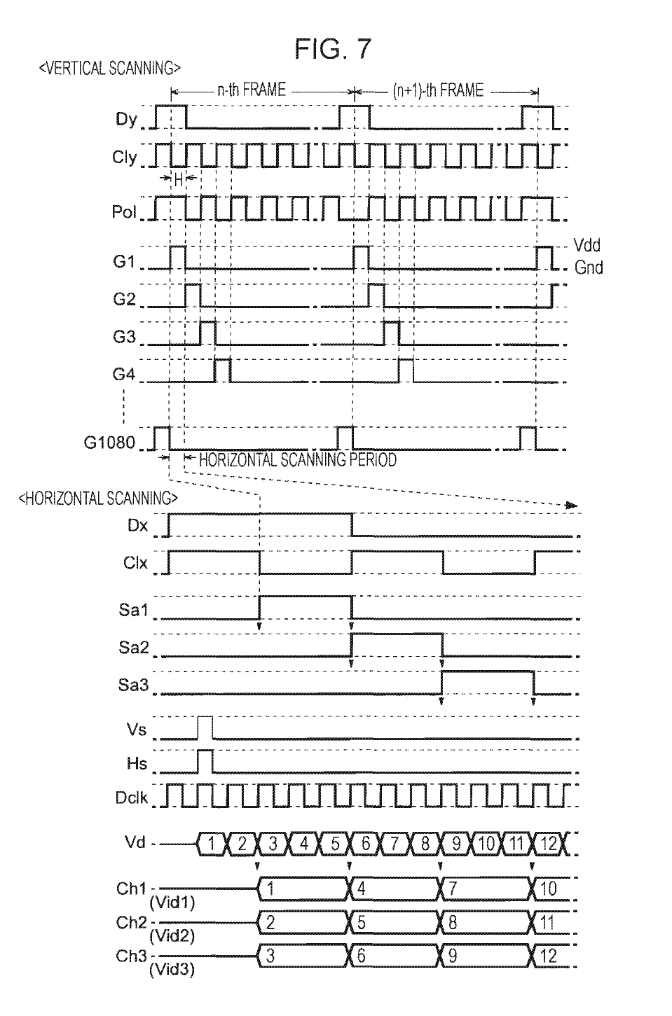

Since the structure of the scanning-line drive circuit 130 does not directly relate to the embodiment of the invention, a description thereof is omitted. A start pulse Dy supplied from the scanning control circuit 60 is sequentially shifted every time the level of a clock signal Cly changes (rises or falls), as shown in FIG. 7, which is followed by waveform shaping or the like, and the result is output as the scanning signals G1, G2, G3, . . . , and G1080. A period in which each of the scanning signals G1, G2, G3, . . . , and G1080 is at H level serves as a horizontal scanning period (H).

The data-line drive circuit 140 includes a sampling-signal output circuit 142 and the n-channel TFTs 144 provided for the corresponding data lines 114.

According to the embodiment, the data lines 114 in the first to 1920-th columns are grouped into blocks of three columns. Since the total of the data lines 114 is 1920, the number of blocks is 640.

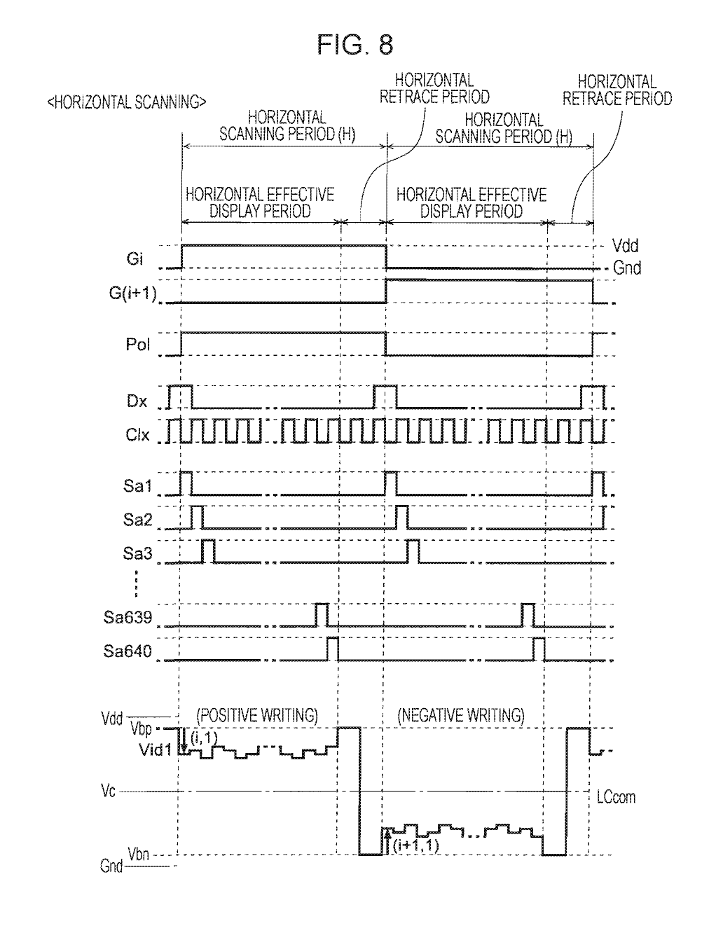

Under control of the scanning control circuit 60, the sampling-signal output circuit 142 outputs sampling signals Sa1, Sa2, Sa3, . . . , and Sa640 corresponding to the blocks. More specifically, the sampling-signal output circuit 142 sequentially shifts a start pulse Dx supplied at the beginning of each horizontal scanning period every time the level of a clock signal Clx changes, as shown in FIG. 7 or 8, which is followed by waveform shaping or the like, and outputs the result as the sampling signals Sa1, Sa2, Sa3, and Sa640.

The data lines 114 in the first to 1920-th columns have two ends. One end of each data line 114 is connected to a drain electrode of a corresponding one of the TFTs 144. In contrast, gate electrodes of the TFTs 144 belonging to the same block are connected to one another. A sampling signal which corresponds to each block and which is output from the sampling-signal output circuit 142 is supplied to the common gate electrodes of the three TFTs 144 belonging to the same block. For example, the second block from the left corresponds to the data lines 114 in the fourth, fifth and sixth columns. Thus, the sampling signal Sa2 is commonly supplied to the gate electrodes of the TFTs 144 corresponding to these data lines 114.

The source electrode of each TFT 144 is connected to one of the three image signal lines 146 in the following manner. That is, in order to generalize the description of the data lines 114, an integer j satisfying 1≦j≦1920 is used. Referring to FIG. 1, the source electrode of the TFT whose drain electrode is connected to one end of the j-th data line 114 from the left is connected to the image signal line 146 to which the data signal Vid1 is supplied if, the remainder of j (the ordinal number of the data line) divided by 3 is 1: the same source electrode is connected to the image signal line 146 to which the data signal Vid2 is supplied if the remainder of j divided by 3 is 2; and the same source electrode is connected to the image signal line 146 to which the data signal Vid3 is supplied if the remainder of j divided by 3 is 0. For example the source electrode of the TFT 144 whose drain electrode is connected to the data line 144 in the eighth column from the left is connected to the image signal line 146 to which the data signal Vid2 is supplied since the remainder of 8 divided by 3 is 2.

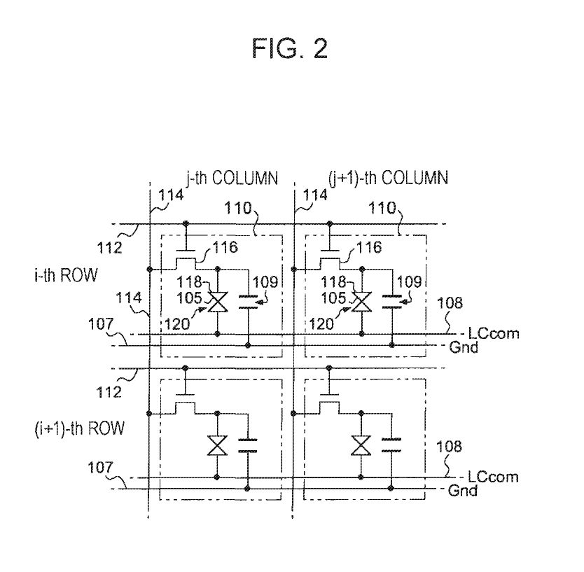

Next, the pixels 110 will be described. FIG. 2 is a diagram of the structure of the pixels 110. More specifically, FIG. 2 shows the structure of four pixels 110 (2×2) corresponding to the intersections of the i-th row and the (i+1)-th row which is adjacent to the i-th in a downward direction and the j-th column and the (1-i-)-th column which is adjacent to the j-th column in a rightward direction. Note that i and (i+1) are symbols for generally describing the rows along which the pixels 110 are arranged. According to the embodiment, is an integer satisfying 1≦i≦1080.

As shown in FIG. 2, the pixels 110 each have an n-channel TFT 116, a liquid crystal capacitor 120, and a storage capacitor 109. Since the pixels 110 have the same structure, the pixel 110 positioned in the i-th row, j-th column is described by way of representative example. In this pixel 110 positioned in the i-th row, j-th column, the gate electrode of the TFT 116 is connected to the scanning line 112 in the i-th row; the source electrode of the TFT 116 is connected to the data line 114 in the j-th column; and the drain electrode of the TFT 116 is connected to a pixel electrode 118.

A counter electrode 108 is commonly provided for all the pixels 110, facing the pixel electrodes 118. The counter electrode 108 is maintained at a constant voltage LCcom. Liquid crystal 105 is sandwiched between the pixel, electrodes 118 and the counter electrode 108. For each of the pixels 110, the liquid crystal capacitor 120 including the pixel electrode 118, the counter electrode 108, and the liquid crystal 105 is provided.

Although not shown in FIG. 2, alignment films are provided on faces of two substrates, the faces facing each other. The alignment films are rubbed so that the long-axis direction of liquid crystal molecules are continuously twisted at, for example, approximately 90 degrees between the substrates. Further, polarizers in accordance with the alignment direction are provided on the back faces of the substrates.

Light passing between the pixel electrodes 118 and the counter electrode 108 is rotated approximately 90 degrees in accordance with the twisting of the liquid crystal molecules if the effective value of voltage applied to the liquid crystal 105 is zero. The larger the voltage effective value becomes, the more the liquid crystal molecules are tilted toward the electric field direction. As a result, the optical activity disappears. For this reason, in the case of a transmissive type by way of example, when polarizers whose polarizing axes are orthogonal to each other in accordance with the alignment directions are provided on an incident side and a back side, white is displayed in which a light transmission factor becomes maximum if the voltage effective value is close to zero. In contrast, the larger the voltage effective value becomes, the density of transmissive light becomes smaller. Eventually, black is displayed in which the transmission factor becomes minimum (normally white mode).

In order to alleviate the effects of leakage in the liquid crystal capacitors 120 via the TFTs 116, the storage capacitors 109 are formed on a pixel-by-pixel basis. Each of the storage capacitors 109 has two ends. One end is connected to the pixel electrode 118 (drain electrode of the TFT 116), and the other end is connected to a capacitor Dine 107 snared by all the pixels 110 and is maintained at a constant potential (e.g., the ground potential Gnd).

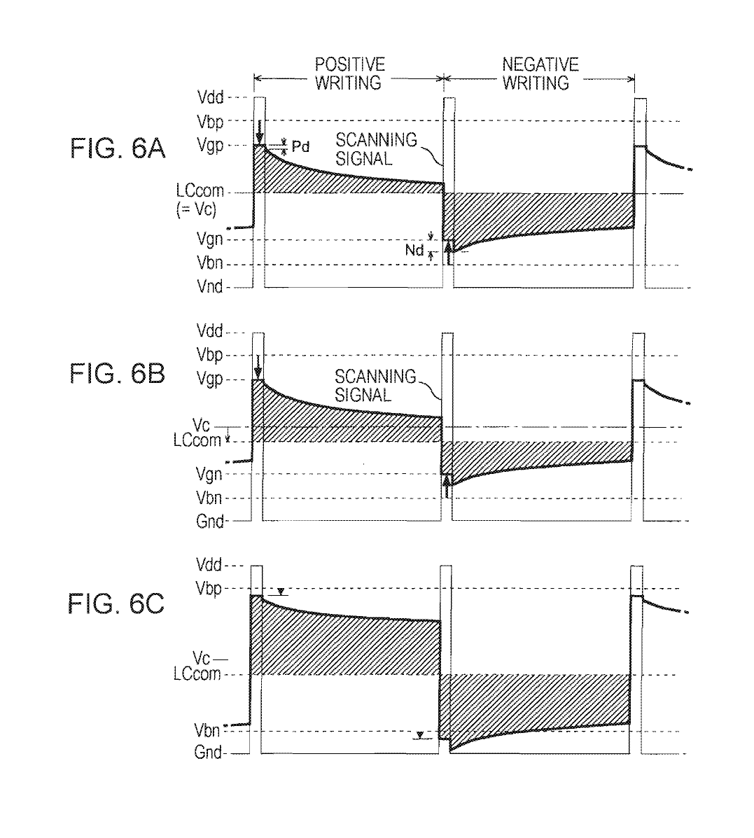

So-called “push-down,” (may also be referred to as “field-through” occurs in the TFTs 116 turning on/off between the data lines 114 and the pixel electrodes 118. More specifically, push-down is the phenomenon in which, as shown in FIG. 6A, in the case where a scanning signal changes from the voltage Vdd corresponding to H level to the potential Gnd corresponding to L level, the voltage of each corresponding pixel electrode 118 is pushed down in the same direction as the change of the voltage of the scanning signal. If push-down occurs, when the scanning signal is at H level, the voltage of a data signal applied to the pixel electrode 118 via a corresponding one of the data lines 114 is shifted, causing application of a DC component to a corresponding one of the liquid crystal capacitors 120.

The main cause of push-down is the parasitic capacitance generated between the gate and drain electrodes of each TFT 116. Push-down is caused when charge accumulated in the liquid crystal capacitance, storage capacitance, and parasitic capacitance when the scanning signal has been at H level is redistributed at the time the scanning signal reaches 1. level. Since the liquid crystal capacitance and the parasitic capacitance have characteristics that change depending on applied voltages, even in the case of data signals specifying the same gray level, a voltage reduction of the pixel electrode 118 caused by push-down differs depending on whether the polarity is positive or negative.

In the case where the TFTs 116 are n-channel type, as shown in FIG. 6A, a voltage reduction Nd caused by push-down in the case where the negative polarity has been specified tends to be greater than a voltage reduction Pd caused by push-down in the case where the positive polarity has been specified.

When light passes between the substrates, part of the light may enter the TFTs 116. If light enters each of the TFTs 116, particularly a channel portion thereof, the off resistance of the TFT 116 becomes smaller even in a period (retention period, during which the scanning signal is maintained at L level at which the TFT 116 is turned off, and a larger amount of charge accumulated in the liquid crystal capacitor 120 leaks via the TFT 116. The amount of leakage is different depending on the voltage difference between the data line 114 and the pixel electrode 118, that is, depending on the polarity and gray level.

In the case of AC driving of liquid crystal by matching the voltage LCcom applied to the counter electrode 108 with the voltage Vc serving as a reference for the writing polarity, due to push-down and leakage difference, as shown in FIG. 6A, the effective value of voltage applied to the liquid crystal capacitor 120 by performing negative writing (hatched area) becomes a little bit larger than the effective value of voltage applied by performing positive writing (provided that the TFT 116 is an n-channel type).

Therefore, as shown in FIG. 6B, the voltage LCcom applied to the counter electrode 108 is separated from the voltage Vc serving as a reference for the writing polarity, and the voltage LCcom is set to be offset lower than the reference voltage Vc.

More specifically, firstly, voltages Vgp and Vgn which turn on the TFTs 116 and 144 and which have the same difference (in terms of absolute value) from the reference voltage Vc (that is, Vgp >Vc >Vgn, and Vgp−Vc=Vc−Vgn) are supplied alternately via the image signal lines 146 on, for example, a frame-by-frame basis, thereby applying the voltages Vgp and Vgn to the pixel electrodes 118. If there is a difference in the effective value of voltage applied to the liquid crystal capacitors 120 between the frames in which the voltage Vgp is applied and the frames in which the voltage Vgn is applied, a difference in brightness, that is, flickering, is caused.

Secondly, the voltage LCcom is adjusted to a point at which no flickering occurs (or flickering becomes minimum). Accordingly, when displaying each pixel 110 with at least a gray level corresponding to the voltages Vgp and Vgn (this gray level is referred to as “G”), a situation where a DC component is applied to each liquid crystal capacitor 120 is avoided.

However, as has been described above, push-down and the amount of leakage differ depending on the polarity and gray level (voltage applied to each pixel electrode 118). Therefore, when the voltages Vgp and Vgn are alternately applied to each pixel electrode 118 on a frame-by-frame basis and the voltage LCcom is set, this is only to avoid application of a DC component to each liquid crystal capacitor 120 in the case where each pixel 110 is displayed with the gray level G, and this is not to avoid application of a DC component to each liquid crystal capacitor 120 in the case where each pixel 110 is displayed with gray levels other than the gray level G. With such settings, flickering occurs in the case where gray levels other than the gray level G are displayed, and it is impossible to avoid application of a DC component to each liquid crystal capacitor 120.

When displaying each pixel 110 with a gray level other than the gray level G after the voltage LCcom has been set, avoidance of application of a DC component to each liquid crystal capacitor 120 requires correcting the voltage of a data signal corresponding to the gray level other than the gray level G (voltage that should be applied to each pixel electrode 118).

In this case, when correcting the voltage of a data signal, it is desirable to suppress the occurrence of flickering while maintaining the gray level (brightness) of each pixel 111 in the case where no correction is performed.

As has been described in the related art, with the technique of correcting only one of positive- and negative-polarity data signals but not correcting the other data signal in order to avoid application of a DC component to liquid crystal capacitors, the voltage effective value of each liquid crystal capacitor does not change in the case of one polarity, but, in the case of the other polarity, the voltage effective value of each liquid crystal capacitor changes by the corrected amount. The average gray level of each pixel throughout two frames of the positive and negative polarities is different from that in the case where no correction is performed.

According to the embodiment, in order to avoid application of a DC component to the liquid crystal capacitors 120, both positive and negative-polarity data signals are corrected. When the voltage effective value of each liquid crystal capacitor 120 is corrected to be smaller in the case of one of the positive and negative polarities (that is, correction is performed to increase the brightness in normally white mode), the voltage effective value of each liquid crystal capacitor 120 is corrected to be larger in the case of the other polarity (that is, correction is performed to reduce the brightness in normally white mode). As a result, the average gray level of each pixel 110 throughout two frames of the positive arid negative polarities is the same as that in the case where no correction is performed at all. A circuit for performing such corrections is a correction circuit 55 included in the image-data processing circuit 50, which will be described thereafter.

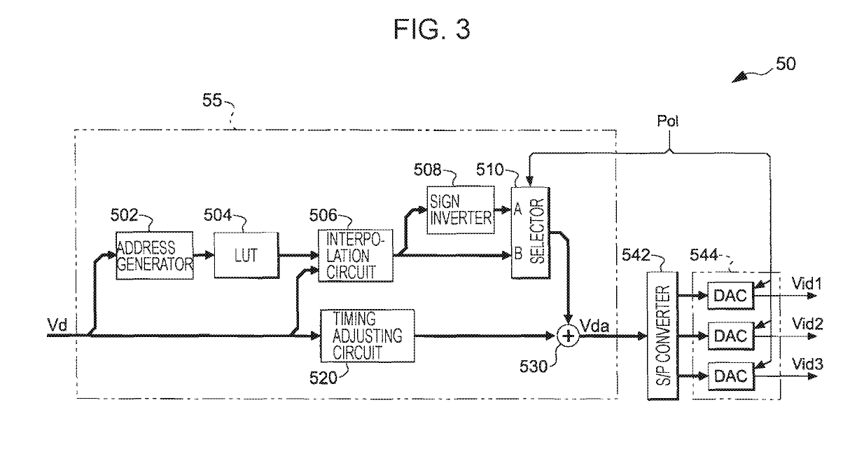

The image-data processing circuit 50 will now be described. FIG. 3 is a block diagram of the structure of the image-data processing circuit 50.

As shown in FIG. 3, the image-data processing circuit 50 includes the correction circuit 55 including an address generator 502, a look-up table (LUT) 504, an interpolation circuit 506, a sign inverter 508, a selector 510, a timing adjusting circuit 520, and an adder circuit 530.

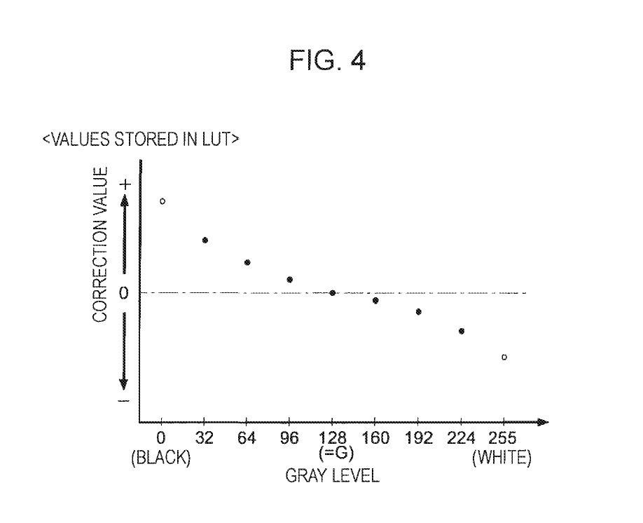

Among these components, the LUT 504 is a storage unit that stores correction values that correspond to gray levels specified by pieces of image data Vd and that correspond to the positive polarity. According to the embodiment, the LUT 504 stores correction values not corresponding to all the gray levels “0” to “255”, but corresponding to some of the gray levels, as shown in FIG. 4. More specifically, the LUT 504 only stores correction values corresponding to the gray levels “32”, “64”, “96”, “128”, “160”, “192”, and “224”, which are indicated by black dots in FIG. 4. These correction values include positive and negative values, as shown in FIG. 4, which will be described later.

The address generator 502 generates an address for reading a correction value corresponding to a gray level specified by image data Vd from the LUT 504. If a gray level specified by image data Vd is a level that corresponds to none of the correction values stored in the LUT 504, the address generator 502 generates addresses for reading at least two correction values positioned before and after the specified gray level.

In the case where a gray level specified by image data Vd corresponds to none of the correction values stored in the LUT 504, the interpolation circuit 506 interpolate the correction values stored in the LUT 504, thereby obtaining the correction value corresponding to the gray level specified by the image data Vd. In the case where a gray level specified by image data Vd is one of the correction values stored in the LUT 504, the interpolation circuit 506 outputs the corresponding one of the correction values stored in the LUT 504.

The sign inverter 508 inverts the sign of the correction value output from the interpolation circuit 506 and outputs the sign-inverted value to an input end A of the selector 510. In contrast, the correction value output from the interpolation circuit 506 is supplied as it is to an input end B of the selector 510.

The selector 510 selects the input end A in the case where a polarity specifying signal Pol is at L level. In contrast, in the case where the polarity specifying signal Pol is at H level, the selector 510 selects the input end B. The selector 510 supplies the sign-inverted value or the correction value supplied to the selected input end to one of two input ends of the adder circuit 530.

The polarity specifying signal Pol is a signal for specifying the polarity into which the data signals Vid1, Vid2, and Vid3 are converted. More specifically, if the polarity specifying signal Pol is at H level, the positive polarity is specified; if the polarity specifying signal Pol is at L level, the negative polarity 's specified. As has been described above, according to the embodiment, a data signal is alternated between the positive and negative polarities on a scanning-line-by-scanning-line basis. Thus, the logic level of the polarity specifying signal Pol is inverted every horizontal scanning period (H) as shown in FIG. 7.

In a certain frame (referred to as an “n-th frame” for convenience), if the polarity specifying signal Pol is at H level in horizontal scanning periods (H) in which. the scanning lines 112 in the odd-numbered (first, third, fifth, . . . , and 1079-th) rows are selected and L level in horizontal scanning periods (H) in which the scanning lines 112 in the even-numbered (second, fourth, sixth, . . . , and 1080-th) rows are selected, in the next frame (referred to as the “(n+1)-th frame” for convenience), the polarity specifying signal Pol is at L level in the horizontal scanning period (H) in which the scanning lines 112 in the odd-numbered rows are selected and H level in the horizontal scanning period (H) in which the scanning lines 112 in the even-numbered rows are selected. Accordingly, the liquid crystal capacitors 120 are AC-driven.

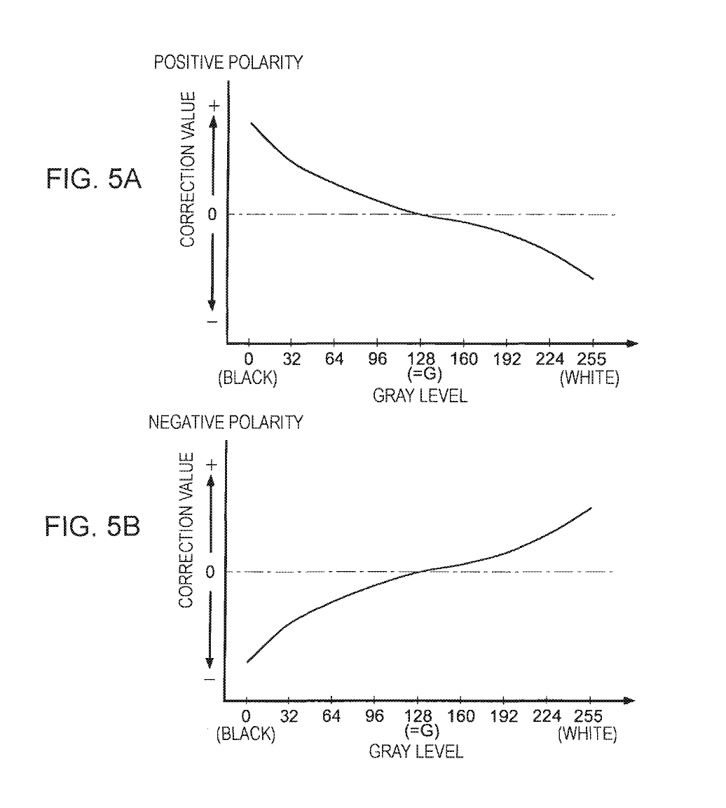

FIG. 5A is a graph showing exemplary characteristics of correction values interpolated by the interpolation circuit 506 in the case where the positive polarity is specified by the polarity specifying signal Pol. In the case where the positive polarity is specified by the polarity specifying signal Pol, correction values corresponding to the gray levels “0” to “255” of image data Vd are output.

FIG. 5B is a graph showing exemplary characteristics of sign-inverted values corresponding to the gray levels of image data Vd in the case where the negative polarity is specified by the polarity specifying signal Pol. The characteristics shown in FIG. 5B are obtained by inverting the sign of the characteristics in the case of the positive polarity shown in FIG. 5A.

The adder circuit 530 adds the correction value or the sign-inverted value supplied to its input end and the image data Vd supplied to the other input end and outputs the sum as corrected image data Vda.

Therefore, in the case where the polarity specifying signal Pol is at H level and the positive polarity is specified, the image data Vd is corrected by adding a correction value corresponding to the gray level. In contrast, in the case where the polarity specifying signal Pol is at L level and the negative polarity is specified, the image data Vd is corrected by adding the sign-inverted value of a correction value corresponding to the gray level (that is, subtracting the correction value corresponding to the gray level from the image data Vd).

Since the adder circuit 530 corrects the image data Vd by adding the correction value (or the sign-inverted value thereof) corresponding to the gray level of the image data Vd, the correction value (or the sign-inverted value thereof) input to one input end and the image data Vd supplied to the other input end must correspond to the same pixel 110.

Therefore, the timing adjusting circuit 520 delays the supply of the image data Vd by a time corresponding to the period from the inputting of the image data Vd to the address generator 502 to the outputting of the correction value (or the sign-inverted value thereof) from the selector 510, thereby adjusting the timing of the correction value (or the sign-inverted value thereof) input to one input end of the adder circuit 530 and the image data Vd supplied to the other input end of the adder circuit 530.

A serial-to-parallel (S/P) converter 542 distributes the corrected image data Vda among three channels and expands these pieces of distributed data three times along the time axis (which is referred to as serial-to-parallel conversion or phase expansion).

A digital-to-analog (D/A) converter group 544 is a set of D/A converters provided on a channel-by-channel basis. The D/A converter group 544 converts serial-to-parallel-converted, corrected image data into analog data signals Vid1, Vid2, and Vid3 having the polarity specified by the polarity specifying signal Pol and outputs the data signals Vid1, Vid2, and Vid3 to the display panel 100.

More specifically, in the case where the positive polarity is specified by the polarity specifying signal Pol in each channel, the D/A converter group 544 converts the phase-expanded, corrected image data into a voltage lower than a positive voltage Vbp serving as a reference by a value specified by the phase-expanded, corrected image data. In contrast, in the case where the negative polarity is specified by the polarity specifying signal Pol, the D/A converter group 544 converts the phase-expanded, corrected image data into a voltage higher than a negative voltage Vbn serving as a reference by a value specified by the phase-expanded, corrected image data.

Therefore, the converted data signal has the voltage Vbp when the value specified by the corrected image data is “0” in the case where positive writing is specified. The larger the specified value, the more distant (the lower) the voltage of the data signal from the voltage Vbp. In contrast, when the value specified by the corrected image data is “0” in the case where negative writing is specified, the data signal has the voltage Vbn. The larger the gray level, the more distant (higher) the voltage of the data signal from the voltage Vbn. The voltages Vbp and Vbn are symmetrical about the voltage Vc (see FIGS. 6A to 6C).

According to the embodiment, since the correction-value or its sign-inverted value supplied to one input end of the adder circuit 530 have the positive/negative sign, if a negative correction value is added in the case where a gray level specified by image data Vd is “0” in terms of decimal value, the sum is negative in terms of decimal value. The D/A converter group 544 converts the image data into a voltage corresponding to the negative value (sum). In this case, the voltage corresponding to the negative value (sum) is a voltage higher than the voltage Vbp in the case where positive writing is specified, and is a voltage lower than the voltage Vbn in the case where negative writing is specified.

In the case where a gray level specified by image data is “255” in terms of decimal value, for example, if the positive correction value “4” is added, the D/A converter group 544 converts the voltage into a voltage corresponding to the gray level “259” serving as the sum.

The correction values stored in the LUT 504 will be described. As shown in FIG. 4, the correction value corresponding to the gray level “128” stored in the LUT 504 is zero. This is because the foregoing gray level “128” serves as the gray level G. chat is, the voltage LCcom is adjusted so that no flickering will be caused by applying the voltages Vgp and Vgn corresponding to the gray level “128” to each pixel electrode 118, and hence the correction value is zero.

Of the correction values stored in the LUT 504, the correction values corresponding to the values other than the correction value “128”, for example, the correction value corresponding to the gray level “32” is determined in the following manner. Specifically, after the voltage LCcom to be applied to the counter electrode 108 has been adjusted, image data Vd specifying the gray level “32” is supplied, and the correction value corresponding to the gray level “32” is set to a temporary value (e.g., zero). Accordingly, positive writing and negative writing are alternately performed. In this state, the effective value of voltage applied to each liquid crystal capacitor 120 is different depending on whether positive writing or negative writing is performed, thereby causing flickering. Therefore, this time, the correction value corresponding to the gray level “32” is increased/decreased so that flickering will become minimum.

With such adjustment, the correction value at a point at which flickering becomes minimum serves as the correction value for the gray level “32”, and this correction value is stored in the LUT 504.

A data signal supplied to each pixel electrode 118 has a voltage lower than the voltage Vbp serving as a reference by a value specified by the corrected image data Vda in the case where positive writing is specified, and has a voltage higher than the voltage Vbn serving as a reference by a value specified by the corrected image data Vda in the case where negative writing is specified.

Therefore, in the case where the correction value is increased, if the positive polarity is specified, the correction value is added to the image data Vd, thereby reducing the voltage of the data signal. If the negative polarity is specified, the sign-inverted value of the correction value is added to the image data Vd, thereby similarly reducing the voltage of the data signal. For example, in the case of image data Vd specifying the gray level “0”, if the correction value is increased in the positive direction, as sow in FIG. 6C, the correction value is added to the image data Vd in the case where the positive polarity is specified. As a result, the voltage of the data signal (voltage applied to the pixel electrode 118) decreases from tile voltage Vbp in the direction indicated by the downward arrow in FIG. 6C. In the case where the negative polarity is specified, the sign-inverted value of the correction value is added to the image data Vd, and hence the voltage of the data signal similarly decreases from the voltage Vbn in the direction indicated by the downward arrow.

In positive writing, a reduction in the voltage of the data signal causes an increase in the brightness of each pixel 110. In negative writing, a reduction in the voltage of the data signal causes a decrease in the brightness of each pixel 110.

In contrast, a reduction in the correction value causes an increase in the voltage of the data signal in the case where the positive polarity is specified. In the case where the negative polarity is specified, a reduction in the correction value similarly causes an increase in the voltage of the data signal. However, an increase in the voltage of the data signal in positive writing causes a decrease in the brightness of each pixel 110. In negative writing, an increase in the voltage of the data signal causes an increase in the brightness of each pixel 110.

Therefore, it can be said that the correction value for the gray level “32”, which has been adjusted so that flickering becomes minimum, has been adjusted so that the average gray level of each pixel 110 does not change throughout two frames of the positive and negative polarities, as compared with the case in which no correction is performed at all, while avoiding application of a DC component to each liquid crystal capacitor 120.

Similarly, correction values for the gray levels “64”, “96”, “160”, “192”, and “224” are obtained, and the correction values obtained are stored in the LUT 504.

Since the gray level “0” sets each pixel 110 to black having the lowest brightness, even if the effective value of voltage applied to each liquid crystal capacitor 120 is different in positive writing and negative writing, flickering is difficult to be perceived. Similarly, since the gray level “255” sets each pixel 110 to white having the highest brightness, even if the effective value of voltage applied to each liquid crystal capacitor 120 is different in positive writing and negative writing, flickering is difficult to be perceived. Therefore, the correction values corresponding to the gray levels “0” and “255” are excluded from those stored in the LUT 504. The same applies to correction values corresponding to gray levels in the vicinity of the gray levels “0” and “255”. Note that a correction value not stored in the LUT 504 is computed by the interpolation circuit 506.

Next, the operation of the electro-optical device 10 will be described.

As shown in FIG. 7, image data Vd corresponding to the pixel 110 in the first row, first column is supplied from the upper-level unit to the image-data processing circuit 50 at the time (pulses of) the vertical scanning signal Vs and the horizontal scanning signal Hs are output. Thereafter, image data Vd is supplied on a pixel-by-pixel basis in synchronization with the dot clock signal Dclk. When image data Vd corresponding to the pixel 110 in the 1920-th column is supplied, the horizontal scanning signal Hs is output again. In the next-row, pieces of image data Vd corresponding to the pixels 110 in the first to 1920-th columns are supplied in a similar manner. When image data Vd corresponding to the pixel 110 in the 1080-th row, 1920-th column serving as the last row, last column is supplied, the data application process proceeds to the next frame. In the next frame, the vertical scanning signal Vs and the horizontal scanning signal Hs are output again, and image data Vd is supplied starting from that corresponding to the pixel 110 in the first row, first column.

In the case where image data Vd is supplied to the image-data processing circuit 50, if a gray level specified by the image data Vd corresponds to one of the correction values stored in the LUT 504, the corresponding one of the correction values is output from the interpolation circuit 506. If the gray level specified by the image data Vd corresponds to none of the correction values stored in the LUT 504, a correction value corresponding to the specified gray level is computed by interpolating the stored correction values, and the correction value computed is output from the interpolation circuit 506. If the positive polarity is specified by the polarity specifying signal Pol for the image data Vd, the correction value output from the interpolation circuit 506 is selected by the selector 510. If the negative polarity is specified, the sign-inverted value of the correction value is selected.

The image data Vd which has been timing-adjusted by the timing adjusting circuit 520 is added by the adder circuit 530 to the correction value or the sign-inverted value selected by the selector 510. As a result, the sum is output as the corrected image data Vda.

A portion of the corrected image data Vda supplied to one row will be examined. The scanning control circuit 60 controls the image-data processing circuit 50, the scanning-line drive circuit 130, and the data-line drive circuit 140 in the following manner. That is, the scanning control circuit 60 controls the image-data processing circuit 50 so that the corrected image data Vda corresponding to the pixels 110 in the first fourth, seventh, tenth, . . . , and 1918-th columns is distributed to channel Ch1, the corrected mage data Vda corresponding to the pixels 110 in the second, fifth, eighths, eleventh, . . . , and 1919-th columns is distributed to channel Ch2, and the corrected image data Vda corresponding to the pixels 110 in the third, sixth, ninth, twelfth, . . . , and 1920-th columns is distributed to channel Ch3. Also, the scanning control circuit 60 controls the scanning-line drive circuit 130 so that a scanning signal corresponding to the line to which the image data Vda is supplied is at H level. At the same time, the scanning control circuit 60 controls the sampling-signal output circuit 142 so that the sampling signal Sa1 is at H level in a period in which the image data Vda corresponding to the pixels 110 in the first to third columns is distributed among the channels Ch1 to Ch3, the sampling signal Sa2 is at H level in a period in which the image data Vda corresponding to the pixels 110 in the fourth to sixth columns is distributed among the channels Ch1 to Ch3, and, in a similar manner, the sampling signal Sa640 is at H level in a period in which the image data Vda corresponding to the pixels 110 in the 1918-th to 1920-th columns is distributed among the channels Ch1 to Ch3.

Since image data Vd supplied from the upper-level unit has been timing-adjusted by the timing adjusting circuit 520, the output timing of the corrected image data Va is, strictly speaking, delayed with respect to the vertical synchronization signal Vs, the horizontal synchronization signal Hs, and the dot clock signal Dclk. Thus, the scanning control circuit 60 controls the image-data processing circuit 50, the scanning-line drive circuit 130, and the data-line drive circuit 140, taking into consideration the timing adjustment performed by the timing adjusting circuit 520.

According to the embodiment, the writing polarity is inverted on a scanning-line-by-scanning-line basis. As has been described above, it is assumed that positive writing is specified for the odd-numbered rows in the n-th frame.

In the case where the scanning signal G1 reaches H level, the pixels 110 positioned in the first row, that is, the TFTs 116 of the pixels 110 positioned from the first row, first column, to the first row, 1920-th column, are turned on. In contrast, in a horizontal scanning period in which the scanning signal G1 is at H level, at first, the sampling signal Sa1 reaches H level. In a period in which the sampling signal Sa1 is at H level, the data signals Vid1, Vid2, and Vid3 supplied to the three image signal lines 146 are converted into positive voltages corresponding to the corrected gray levels of the pixels 110 in the first row, first column the first row, second column, and the first row, third column. Since the sampling signal Sa1 is at H level, the TFTs 144 in the first, second, and third columns belonging to the first block are turned on. Accordingly, the data signals Vid1, Vid2, and Vid3 supplied to the image signal lines 146 are sampled to the data lines 114 in the first, second, and third columns, respectively. Thus, positive voltages according to the gray levels are applied to the pixel electrodes 118 in the first row, first column, the first row, second column, and the first row, third column via the TFTs 116 which have been turned on.

In the horizontal scanning period in which the scanning signal G1 is at H level, next, the sampling signal Sa2 reaches H level. The data signals Vid1, Vid2, and Vid3 supplied to the image signal lines 146 in a period in which the sampling signal Sa2 is at H level have positive voltages corresponding to the gray levels of the pixels 110 in the first row, fourth column, the first row, fifth column, and the first row, sixth column. Since the sampling signal Sa2 is at H level, the TFTs 144 in the fourth, fifth, and sixth columns belonging to the second block are turned on. Accordingly, the data signals Vid1, Vid2, and Vid3 supplied to the image signal lines 146 are sampled to the data lines 114 in the fourth, fifth, and sixth columns, respectively. Thus, positive voltages according to the gray levels are applied to the pixel electrodes 118 in the first row, fourth column, the first row, fifth column, and the first row, sixth column via the TFTs 116 which have been turned on.

Similarly, the sampling signals Sa3, Sa4, . . . , and Sa640 sequentially reach H level, and the data signals Vid1 to Vid3 are sampled to the data lines 114 in three columns belonging to the third, fourth, . . . , and 640-th blocks in order. As a result, positive writing in accordance with the gray levels is performed on the pixels 110 in the first row and first to 1920-th columns.

Next, in the n-th frame, a horizontal scanning period in which the scanning signal G2 is at H level will be described. According to the embodiment, the writing polarity is inverted on a scanning-line-by-scanning-line basis, as has been described above. For the pixels 110 in the second row, negative writing is specified.

When the scanning signal G2 reaches H level, the pixels 110 positioned in the second row, that is, the TFTs 116 positioned from the second row, first column, to the second row, 1920-th column, are turned on.

In the horizontal scanning period in which the scanning signal G2 is at H level, the data signals Vid1, Vid2, and Vid3 supplied to the image signal lines 146 in a period in which the sampling signal Sa1 is at H level are converted into negative voltages corresponding to the gray levels of the pixels 110 in the second row, first column, the second row, second column, and the second row, third column. Thus, negative voltages according to the gray Levels are applied to the pixel electrodes 118 in the second row, first column, the second row, second column, and the second row, third column via the TFTs 116 which have been turned on.

For the remaining portions, a process similar to that in the case of the horizontal scanning period in which the scanning signal G1 is at H level is performed. The sampling signals Sa2, Sa3, Sa4, . . . , and Sa640 sequentially reach H level, and the data signals Vid1 to Vid3 are sampled to the data lines 114 in three columns belonging to the second, third, fourth, . . . , and 640-th blocks in order. As a result, negative writing in accordance with the gray levels is performed on the pixels 110 in the second row and first to 1920-th columns.

In the n-th frame, from this point onward, positive writing in accordance with the gray levels is performed on the pixels 110 in the odd-numbered (third, fifth, seventh, . . . , and 1079--th) rows, and negative writing in accordance with the gray levels is performed on the pixels 110 in the even-numbered (fourth, sixth, eighth, . . . , and 1080-th) rows.

In the next (n+1)-th frame, similar writing is performed. In this case, since the logic level of the polarity specifying signal Pol is inverted on a row-by-row basis, the writing polarity is switched on a row-by-row basis. That is, in the next (n+1)-th frame, negative writing is performed on the pixels 110 in the odd-numbered rows. In contrast, positive writing is performed on the pixels 110 in the even-numbered rows.

FIG. 8 is a chart showing an exemplary voltage waveform of the data signal Vid1 in a period in which scanning lines in the odd-numbered i-th row and the subservient (i+1)-th row are selected. As a matter of convenience, the vertical scale showing the voltage of the data signal Vid1 in FIG. 8 is enlarged, as compared with the vertical scales of other signals.

As shown in FIG. 8, in the n-th frame in which positive writing is specified for the odd-numbered i-th row, in a horizontal scanning period in which the scanning signal G1 is at H level, for example, in a period in which the sampling signal Sa1 is at H level, the data signal Vid1 becomes lower than the voltage Vbp by a voltage corresponding to the gray level of the pixel 110 in the i-th row, first column (indicated by the downward arrow in FIG. 8). Thereafter, as the sampling signal changes, the data signal Vid1 changes to positive voltages according to the gray levels of the pixels 110 in the fourth, seventh, tenth, and 1918-th columns.

In contrast, in the even-numbered (i+1)-th row, the writing polarity is inverted, and negative writing is specified. In a horizontal scanning period in which the scanning signal G(i+1) is at H level, for example, in a period in which the sampling signal Sa1 is at H level, the data signal Vid1 becomes higher than the volts age Vbn by a voltage corresponding to the gray level of the pixel 110 in the i-th row, first column (indicated by the upward arrow in FIG. 8). Thereafter, as the sampling signal changes, the data signal Vid1 changes to positive voltages according to the gray levels of the pixels 11 in the fourth, seventh, tenth, . . . , and 1918-th columns.

In FIG. 8, the voltage corresponds to black in a horizontal retrace period from the point at which the sampling signal Sa640 reaches L level to the point at which the sampling signal Sa1 changes. This is intended to avoid any effect on display caused by pixel writing errors due to timing errors or the like.

According to the embodiment, image data Vda corrected by the correction circuit 55 is converted into the polarity specified by the polarity specifying signal Pol, and the converted image data Vda is supplied as data signals to corresponding pixel electrodes 118 via the image signal lines 146, the TFTs 144, the data lines 114, and the TFTs 116. In this manner, flickering does not become noticeable, and, as compared with the case in which no correction is performed, changes in the gray levels can be reduced.

According to the embodiment, the data lines 114 in three columns are organized as a block, and the data signals Vid1 to Vid3 which have been converted and distributed among three channels are sampled to the respective data lines 114 in three columns belonging to one block. However, the number of channels and the number of data lines to which the data signals are applied at the same time (that is, the number of data lines constituting one block) is not limited to three. For example, if the response speed of the TFTs 144 functioning as sampling switches is sufficiently high, instead of performing serial-to-parallel conversion, data may be serially transmitted via one image signal line, and sampling may be sequentially performed according to each data line 114. Alternatively, the number of channels and the number of data lines to which the data signals are applied at the same time may be a number other than three, such as two, or a number greater than or equal to four, such as six.

According to the embodiment, the correction values for use in the case of positive-polarity conversion are stored in the LUT 504. Alternatively, correction values for use in negative-polarity conversion (see FIG. 5B) may be stored in the LUT 504, and, the sign of the correction values stored may be inverted for use in positive-polarity conversion.

According to the embodiment, normally white mode has been employed in which white is displayed in the case where the effective value of voltage between the counter electrode 108 and the pixel electrodes 118 is small. Alternatively, normally black mode in which black is displayed in such a case may be employed.

Further, although a transmissive type has been employed in the embodiment, a reflection type may be employed. Besides twisted nematic (TN) liquid crystal, used in he foregoing embodiment, possible types of liquid crystal include bistable liquid crystal with memory effects, such as bistable twisted nematic (BTN) liquid crystal and ferroelectric liquid crystal; polymer dispersion liquid crystal; and guest-host (GH) liquid crystal in which a dye (guest) with different visible-light absorbencies between the long and short axes of molecules is dissolved in liquid crystal (host) with a certain molecular arrangement such that the dye molecules and the liquid crystal molecules can be arranged in parallel.

The structure may be based on vertical alignment (homeotropic alignment) in which the liquid crystal molecules are aligned vertically with respect to the two substrates when no voltage is applied and aligned horizontally with respect to the substrates when voltage is applied, or on parallel (horizontal) alignment (homogeneous alignment) in which the liquid crystal molecules are arranged horizontally with respect to the substrates when no voltage is applied and aligned vertically with respect to the substrates when voltage is applied. Accordingly, the embodiment of the invention is applicable to various types of liquid crystal and alignment.

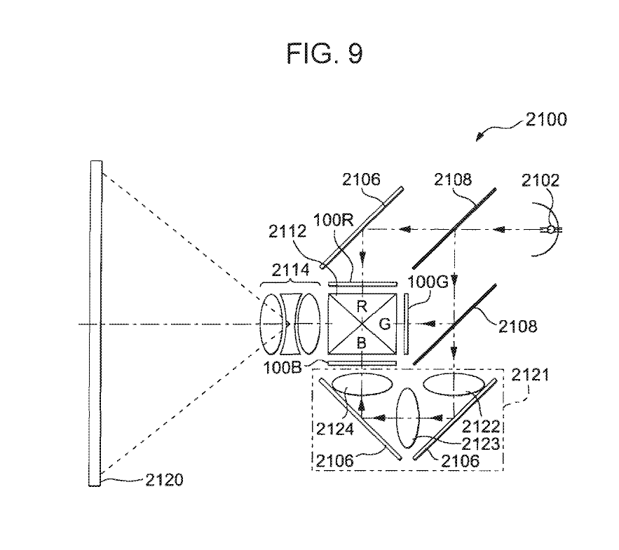

Next, a projector using the display panel 100 of the above-described electro-optical device 10 as a light valve will be described as an exemplary electronic apparatus using the electro-optical device according to the foregoing embodiment. FIG. 9 is a plan view of the structure of the projector.

As shown in FIG. 9, a lamp unit 2102 including a white light source, such as a halogen lamp or the like, is provided in a projector 2100. Projection light emitted from the lamp unit 2102 is separated by three mirrors 2106 and two dichroic mirrors 2108 provided inside the projector 2100 into three primary colors, namely, red (R), green (G), and blue (B), which are directed to respective light valves 100R, 100G, and 100B corresponding to the three primary colors R, G, and B. Since blue light has a longer optical path than those of red light and green light, blue light is directed via a relay lens system 2121 including an incident lens 2122, a relay lens 2123, and an emission lens 2124 in order to reduce or eliminate loss.

The structure of the light valves 100R, 100G, and 100B is similar to that of the display panel 100 according to the foregoing embodiment.

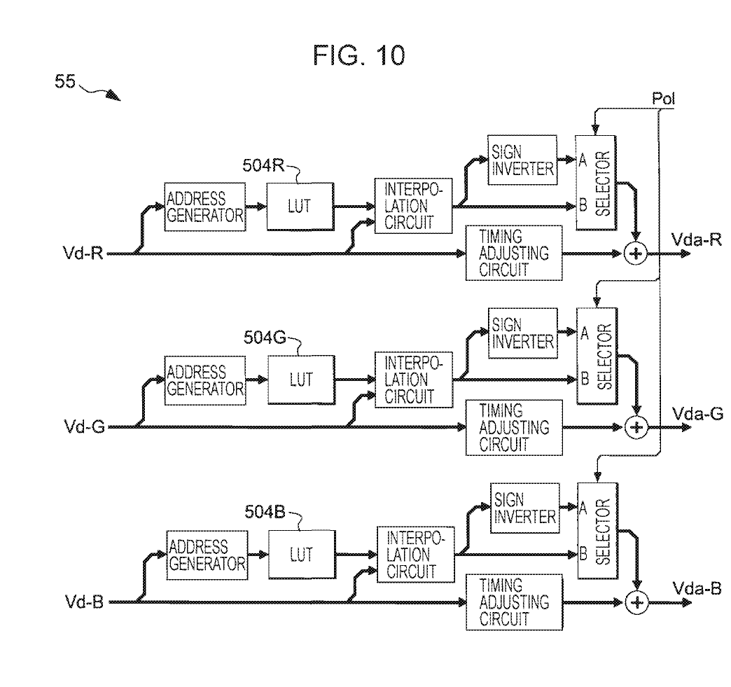

Image data Vd-R, Vd-G, and Vd-B corresponding to R. G, and B, respectively, are corrected by a circuit such as a correction circuit 55′ shown in FIG. 10, and the light valves 100R, 100G, and 100B are driven by data signals which are based on the corrected image data Vda-R, Vda-G, and Vda-B and which correspond to R, G, and B, respectively. The correction circuit 55′ shown in FIG. 10 includes three correction circuits 55 shown in FIG. 3, which correspond to R, G, and B, respectively. Since the S/P converter 542 and the D/A converter group 544 are the same as those shovel in FIG. 3, they are omitted in FIG. 10.

Therefore, three electro-optical devices 10 each including the display panel 100 are provided for R, G, and B, respectively.

Since the light valves 100R, 100G, and 100B have the same electrical structure, they have substantially similar characteristics. Therefore, in the correction circuit 55′ shown in FIG. 10, an LUT 504R corresponding to R, an LUT 504G corresponding to G, and an LUT 504B corresponding to B store the same correction values. That is, in the case where values set by the foregoing adjustment are used for any one of R, G, and B, these correction values for storage in the LUTs can be shared among R, G, and B.

Light components modulated by the light valves 100R, 100G, and 100B enter a dichroic prism 2112 from three directions. The dichroic prism 2112 refracts red light and blue light at 90 degrees, whereas allowing green light to travel straight. After red, green, and blue images are combined, a color image is projected by a projection lens 2114 onto a screen 2120.

Since the dichroic mirrors 2108 allow light components corresponding to the primary colors R, G, and B to pass through the light valves 100R, 100G, and 100B, respectively, it is not necessary to provide a color filter, as in the case of a direct-viewing type. Although transmitted images from the light valves 100R and 100B are reflected from the dichroic prism 2112 and then projected, a transmitted image from the light valve 100G is directly protected. Therefore, the horizontal scanning direction of the light valves 100R and 100B is reversed from that of the light valve 100G to form horizontally-flipped images.

In the foregoing case, three electro-optical devices corresponding to R, G, and B are used. Alternatively, for example, color corresponding to G may be separated into two colors: one closer to R and the other closer to B. Accordantly, a total of four images are combined to produce a color image, which is then projected. With this structure, four electro-optical devices are provided. Since light valves of the four electro-optical devices have the same structure, similarly, correction values stored in LUTs of the four electro-optical devices are the same.

Exemplary electronic apparatuses include, besides the projector shown in FIG. 9, a television, viewfinder-type and monitor-direct-viewing type video recorders, a car navigation apparatus, a pager, an electronic notepad, a calculator, a word processor, a workstation, a videophone, a point-of-sale (POS) terminal, a digital still camera, a cellular phone, and an apparatus with a touch panel. It will be obvious that the electro-optical device according to the embodiment of the invention is applicable to these various electronic apparatuses.

The entire disclosure of Japanese Patent Application No. 2007-021970, filed Jan. 31, 2007 is expressly incorporated by reference herein.

What is claimed is:

1. A processing circuit for correcting image data specifying a gray level of a pixel and for converting the image data alternately into a positive data signal and a negative data signal, the positive data signal having a positive voltage with reference to a predetermined potential on the basis of the corrected image data the negative data signal having a negative voltage with reference to a predetermined potential on the basis of the corrected image data, the circuit comprising:
a storage unit that stores a correction value for correcting tie image data in association with the gray level specified by the image data in the case where the image data is to be converted into the data signal with one of the positive voltage and the negative voltage; and
an adder circuit that adds, when converting the image data into one of the positive and negative data signals, the correction value stored in the storage unit to the image data, and, when converting the image data into the other of the positive and negative data signal, adds a sign-inverted value of the correction value stored in the storage unit to the image data, and outputs the sum as the corrected image data.

2. The processing circuit according to claim 1, wherein the storage unit stores correction values corresponding to some of gray levels specifiable by pieces of image data, the processing circuit further comprising:
an interpolation circuit that computes a correction value corresponding to, among the gray levels specifiable by the pieces of image data, a gray level other than the gray levels corresponding to the stored correction values by interpolating the stored correction values.

3. The processing circuit according to claim 1, further comprising a timing adjusting circuit that delays supply of the image data to the adder circuit by a time required for computing the correction value corresponding to the image data or the sign-inverted value of the correction data and to supply the delayed image data to the adder circuit.

4. A processing method of correcting image data specifying a gray level of a pixel and converting the image data alternately into a positive data signal and a negative data signal, the positive data signal having a positive voltage with reference to a predetermined potential on the basis of the corrected image data, the negative data signal having a negative voltage with reference to a predetermined potential on the basis of the corrected image data, the method comprising:
storing in advance a correction value for correcting the image data in association with the gray level specified by the image data in the case where the image data is to be converted into the data signal with one of the positive voltage and the negative voltage; and
adding, when converting the image data into one of the positive and negative data signals, the stored correction value to the image data, and, when converting the image data into the other of the positive and negative data signal, adding a sign-inverted value of the stored correction value to the image data, and outputting the sum as the corrected image data.

5. An electro-optical device comprising:
a processing circuit that corrects image data specifying a gray level of a pixel and converts the image data alternately into a positive data signal and a negative data signal, the positive data signal having a positive voltage with reference to a predetermined potential on the basis of the corrected image data, the negative data signal having a negative voltage with reference to a predetermined potential on the basis of the corrected image data;
a plurality of pixels provided at intersections between a plurality of scanning lines in rows and a plurality of data lines in columns, wherein each of the pixels is displayed with a gray level in accordance with a voltage of a data signal supplied to a corresponding one of the data lines in the case where a corresponding one of the scanning lines is selected;
a scanning-line drive circuit that selects the plurality of scanning lines in rows one at a time in a predetermined sequence; and
a data-line drive circuit that supplies data signals processed by the processing circuit to pixels positioned along a selected scanning line via the corresponding data lines,
wherein the processing circuit includes:
a storage unit that stores a correction value for correcting the image data in association with the gray level specified by the image data in the case where the image data is to be converted into the data signal with one of the positive voltage and the negative voltage; and
an adder circuit that adds, when converting the image data into one of the positive and negative data signals, the correction value stored in the storage unit to the image data, and, when converting the image data into the other of the positive and negative data signal, adds a sign-inverted value of the correction value stored in the storage unit to the image data, and outputs the sum as the corrected image data.

6. A projector comprising:
at least three electro-optical devices according to claim 5, the at least three electro-optical devices corresponding to primary colors,
wherein images generated by the at least three electro-optical devices are combined, and
wherein at least three storage units included in the at least three electro-optical devices store the same correction values.
